(19) United States
(12) Patent Application Publication
(10) Pub. No.: US 2026/0107885 A1
(43) Pub. Date: Apr. 23, 2026

(54) VINE TRELLIS AND A PLANTING DEVICE

(71) Applicant: Vego Innovations, Inc., Tomball, TX (US)

(72) Inventors: GUANGYUAN XIONG, Tomball, TX (US); ZHULIN LIU, Tomball, TX (US); HONGJIE YAN, Tomball, TX (US)

(21) Appl. No.: 18/956,050

(22) Filed: Nov. 22, 2024

(30) Foreign Application Priority Data
Oct. 17, 2024 (CN) 2024225218090

(51) Int. Cl. A01G 17/06; A01G 9/28

(52) U.S. Cl. CPC A01G 17/06; A01G 9/28; A01G 2017/065

(57) ABSTRACT

This application provides a vine trellis and a planting device. The first side rod and the second side rod of the vine trellis are provided on both sides of a garden bed of the planting device. The first connecting rod is connected between the first side rod and the second side rod. The second connecting rod is connected between the first side rod and the second side rod, or the second connecting rod is connected to the garden bed. The rope is threaded through a plurality of rope pulling members provided on the first side rod, the second side rod, the first connecting rod and the second connecting rod to form a net required for climbing.

### CROSS-REFERENCE TO RELATED APPLICATIONS

The present disclosure claims priority of the Chinese Patent application No. 2024225218090 entitled “A VINE TRELLIS AND A PLANTING DEVICE” filed on Oct. 17, 2024, to the China National Intellectual Property Administration, the entire contents of which are incorporated herein by reference.

### FIELD

The present disclosure relates to the technical field of garden facilities, and in particularly to a vine trellis and a planting device.

### BACKGROUND

Since vine plants can form a wall of plants or a sea of flowers, they are very popular among people. When planting vine plants, it is necessary to set up a trellis for vine plants to climb. Usually, people directly insert the trellis into the soil, allowing vine plants to grow along the trellis. This method not only has the problem of unstable fixation of the trellis, but also has the problem of a single climbing direction, which does not allow people to set the climbing direction according to their preferences and the growth characteristics of vine plants.

### SUMMARY

The main purpose of this application is to provide a vine trellis and a planting device. The vine trellis can provide a stable support required for vine plants to climb, and at the same time, it can also make the climbing direction of vine plants more diversified.

In an embodiment, this application provides a vine trellis, applied to a planting device, the vine trellis includes: a first side rod and a second side rod, the first side rod and the second side rod are respectively provided on both sides of a garden bed of the planting device; a first connecting rod, the first connecting rod is connected between the first side rod and the second side rod; a second connecting rod, the second connecting rod is connected between the first side rod and the second side rod, or the second connecting rod is connected to the garden bed; a plurality of rope pulling members, the plurality of rope pulling members are respectively provided on the first side rod, the second side rod, the first connecting rod and the second connecting rod; a rope, the rope is threaded through the plurality of rope pulling members to form a net required for climbing.

In an embodiment, distances between the plurality of rope pulling members provided on the first side rod, the second side rod, the first connecting rod and the second connecting rod are adjustable, which makes a mesh pattern of the net be adjusted according to a growth of plants.

In an embodiment, the plurality of rope pulling members are fixedly provided on the first side rod, the second side rod, the first connecting rod and the second connecting rod.

In an embodiment, the plurality of rope pulling members are provided on the first side rod, the second side rod, the first connecting rod and the second connecting rod at equal intervals.

In an embodiment, the first side rod, the second side rod, the first connecting rod and the second connecting rod are all provided with at least one slot channel, a rope pulling member is threaded through a slot channel, moved to a preset position along the slot channel and fixed at the preset position.

In an embodiment, the first side rod and the second side rod are respectively detachably installed on an inner wall or outer wall of both sides of the garden bed through at least one connecting member.

In an embodiment, a connecting member includes: a clamping body, the clamping body is provided with a first through-hole, one end of the clamping body is shaped to fit a side wall of the garden bed, the other end of the clamping body extends with two clamping parts, the two clamping parts form a clamping space, the clamping space is for placing the first side rod or the second side rod; a first screw and a first nut, the first screw is threaded through the first side rod or the second side rod, the first through-hole and the garden bed and connected in the first nut to use the clamping body to install the first side rod or the second side rod on the garden bed.

In an embodiment, a plurality of hollow portions spaced apart are provided on one side of the clamping part that is opposite to the first side rod or the second side rod, the two clamping parts respectively are provided with a second through-hole; the clamping body further includes a clamping cover, the clamping cover covers the plurality of hollow portions and the second through-hole.

In an embodiment, the rope is threaded through different rope pulling members to form the net with different structures.

In an embodiment, a rope pulling member includes a rope pulling part and a second screw connected to the rope pulling part, the first side rod, the second side rod, the first connecting rod and the second connecting rod are all provided with at least one screw hole, the second screw is connected in a screw hole to install the rope pulling member on the first side rod, the second side rod, the first connecting rod and the second connecting rod; or a rope pulling member includes a rope pulling part, a second screw connected to the rope pulling part and a second nut, the first side rod, the second side rod, the first connecting rod and the second connecting rod are all provided with at least one third through-hole, the second screw is threaded through a third through-hole and connected in the second nut to install the rope pulling member on the first side rod, the second side rod, the first connecting rod and the second connecting rod.

In an embodiment, the shape of the rope pulling part includes a round ring, a square ring and/or a hook.

In an embodiment, the first side rod, the second side rod, the first connecting rod and the second connecting rod all include a plurality of sub-rods, the plurality of sub-rods are detachably connected to lengthen or shorten lengths of the first side rod, the second side rod, the first connecting rod and the second connecting rod.

In an embodiment, the vine trellis further includes a reinforcing rib, the reinforcing rib is connected between the first side rod and the first connecting rod, between the first side rod and the second connecting rod, between the second side rod and the first connecting rod, or between the second side rod and the second connecting rod.

In an embodiment, this application further provides a planting device, the planting device includes: a garden bed, the garden bed is configured to place plants; a vine trellis, the vine trellis is connected with the garden bed, the vine trellis is any vine trellis provided by this application.

### BRIEF DESCRIPTION OF THE DRAWINGS

In order to more clearly illustrate the technical solutions of the embodiments of this application, the following will briefly introduce the drawings used in the description of the embodiments. Apparently, the drawings in the following description are some embodiments of this application. For those of ordinary skill in the art, without making any creative efforts, other drawings can be obtained based on these drawings.

FIG. 1 is a structural diagram of a planting device provided in an embodiment of this application.

FIG. 2 is an enlarged structural diagram of the area marked A in FIG. 1.

FIG. 3a is a structural diagram of a garden bed provided in an embodiment of this application.

FIG. 3b is a structural diagram of a vine trellis provided in an embodiment of this application.

FIG. 4 is an enlarged structural diagram of the area marked B in FIG. 1.

FIG. 5 is a structural exploded diagram of a connecting member and a first side rod provided in an embodiment of this application.

FIG. 6 is a structural exploded diagram of a connecting member provided in an embodiment of this application.

FIG. 7 is a partial structural diagram of a first side rod provided in an embodiment of this application.

FIG. 8 is an enlarged structural diagram of the area marked C in FIG. 7.

FIG. 9 is a partial structural diagram of a vine trellis provided in an embodiment of this application.

FIG. 10 is a partial structural diagram of a vine trellis provided in an embodiment of this application.

FIG. 11 is a partial structural diagram of a first side rod provided in an embodiment of this application.

FIG. 12 is a structural diagram of a planting device provided in an embodiment of this application.

FIG. 13 is a structural diagram of a planting device provided in an embodiment of this application.

FIG. 14 is a structural diagram of a planting device provided in an embodiment of this application.

### DETAILED DESCRIPTION

The technical solutions of embodiments of this application are described in detail in connection with the accompanying drawings. Described embodiments are some embodiments of this application, not all embodiments. Based on embodiments of this application, all other embodiments obtained by those of ordinary skill in the art without creative efforts are within the scope of this application. In no conflicting situations, the embodiments and features within the embodiments described below can be combined with each other.

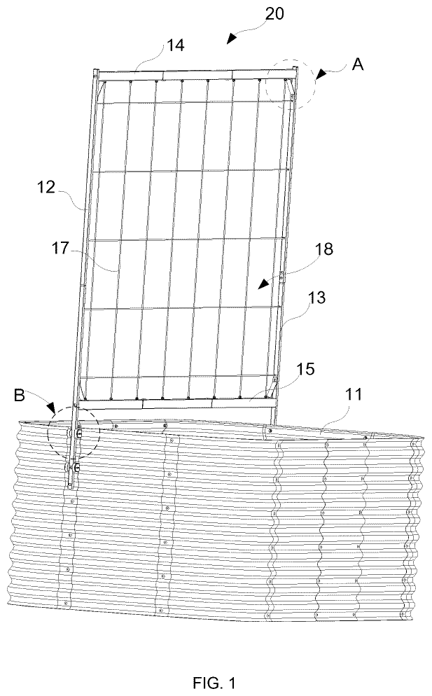

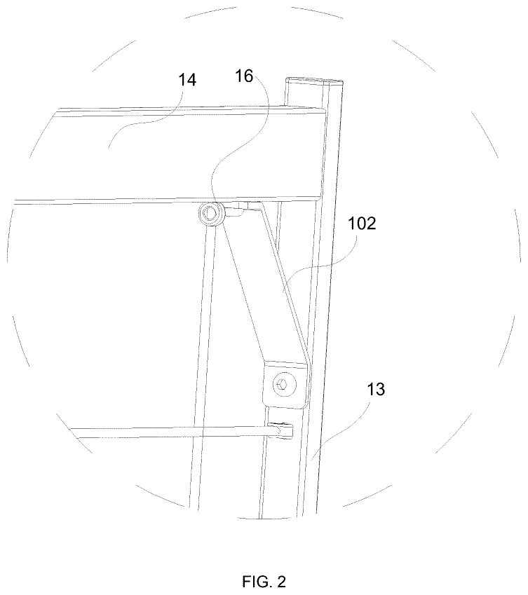

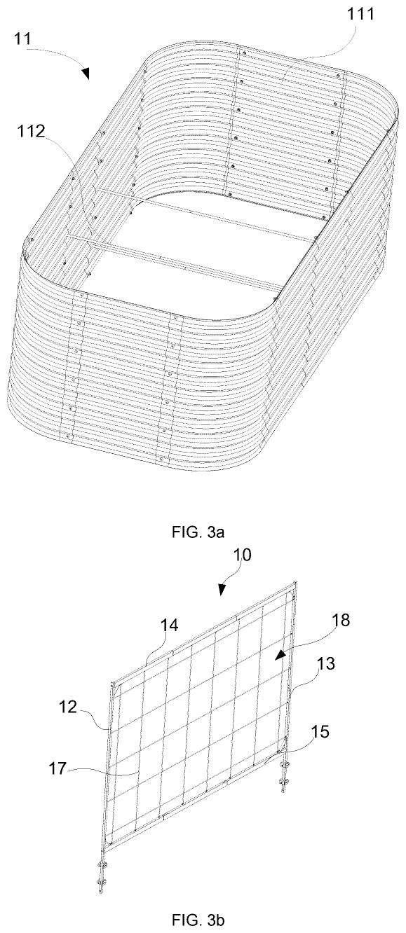

Please refer to FIG. 1, FIG. 2, FIG. 3a and FIG. 3b, FIG. 1 is a structural diagram of a planting device provided in an embodiment of this application. FIG. 2 is an enlarged structural diagram of the area marked A in FIG. 1. FIG. 3a is a structural diagram of a garden bed provided in an embodiment of this application. FIG. 3b is a structural diagram of a vine trellis provided in an embodiment of this application. The planting device 20 includes a vine trellis 10 and a garden bed 11.

In an embodiment, the garden bed 11 is configured to place plants. The plants can be vine plants. When vine plants are placed into the garden bed 11, and since the vine trellis 10 is fixedly connected with the garden bed 11, it is equivalent that the vine plants and the vine trellis 10 form a whole, so that the vine trellis 10 can provide a more stable support for vine plants.

In an embodiment, as shown FIG. 3a, the garden bed 11 includes an enclosing fence 111 and at least one support rod 112. The enclosing fence 111 forms a accommodating space. The accommodating space is configured to place plants. The support rod 112 is connected to the enclosing fence 111. The support rod 112 is configured to reinforce the stability of the enclosing fence 111, thereby improving the stability of the planting device 20.

It should be noted that, the number of the support rod 112 can be one, and can also be plural. The positions where the support rod 112 is connected to the enclosing fence 111 are also not limited to the positions shown in FIG. 3a. They can be set according to the actual situation and are not specifically limited here.

In this embodiment, the vine trellis 10 is connected with the garden bed 11. The vine trellis 10 includes at least one first side rod 12, at least one second side rod 13, at least one first connecting rod 14, at least one second connecting rod 15, a plurality of rope pulling members 16 and at least one rope 17.

The first side rod 12 and the second side rod 13 are respectively provided on both sides of the garden bed 11. The first connecting rod 14 is connected between the first side rod 12 and the second side rod 13. The second connecting rod 15 is connected between the first side rod 12 and the second side rod 13.

It should be noted that, in the vine trellis 10 shown in FIG. 3b, the second connecting rod 15 is connected between the first side rod 12 and the second side rod 13. In other embodiments, the second connecting rod 15 can also be connected to the garden bed 11.

As shown in FIG. 1 and FIG. 2, in order to form the net 18 required for vines plants to climb, the rope pulling members 16 are respectively provided on the first side rod 12, the second side rod 13, the first connecting rod 14 and the second connecting rod 15, and the number of the rope pulling members 16 is plural. In this way, when the rope 17 is threaded through a plurality of rope pulling members 16, the net 18 required for climbing can be formed.

It should be noted that, the number of the rope pulling members 16 provided on the first side rod 12, the second side rod 13, the first connecting rod 14 and the second connecting rod 15 can be the same or different. No specific limitation is made here.

In an embodiment, the type of the rope 17 can include a cord, a metal chain, etc., as long as it can be used in conjunction with the rope pulling members 16 to form the net 18 required for climbing. The number of the rope 17 can be one, two or more. For example, when the number of the rope 17 is one, the rope 17 can be sequentially threaded into a plurality of rope pulling members 16 in a certain order to form the net 18. For example, when the number of the rope 17 is two, one rope 17 can be threaded through a plurality of rope pulling members 16 provided on the first side rod 12 and the second side rod 13 in a certain order to form a horizontal climbing line; the other rope 17 can be threaded through a plurality of rope pulling members 16 provided on the first connecting rod 14 and the second connecting rod 15 in a certain order to form a vertical climbing line; the horizontal climbing line and the vertical climbing line together form the net 18 required for vine plants to climb.

It should be understood that, the first side rod 12, the second side rod 13, the first connecting rod 14 and the second connecting rod 15 may not be limited to the straight rods shown in FIG. 3b, but can also be rods with other shapes. For example, the first connecting rod 14 can be an upward-arching rod. In this way, the appearance of the vine trellis 10 can be beautified, so that the vine trellis 10 not only has strong practicability but also has good ornamental value.

The planting device 20 provided by this embodiment can provide a stable support required for vine plants to climb, and it can also provide more climbing directions for vine plants.

Please refer to FIG. 1, FIG. 2 and FIG. 3b, in this embodiment, the vine trellis 10 includes at least one first side rod 12, at least one second side rod 13, at least one first connecting rod 14, at least one second connecting rod 15, a plurality of rope pulling members 16 and at least one rope 17.

In this embodiment, at least one first side rod 12 and at least one second side rod 13 are respectively provided on both sides of a garden bed 11 of the planting device 20.

In an embodiment, the first side rod 12 and the second side rod 13 can be installed on an inner wall or outer wall of both sides of the garden bed 11. The outer wall refers to the side of the garden bed 11 that is away from the plants. The inner wall refers to the side of the garden bed 11 that faces the plants. For example, as shown in FIG. 1, the first side rod 12 and the second side rod 13 are respectively installed on the outer wall of both sides of the garden bed 11.

It should be understood that, in other embodiments, the first side rod 12 and the second side rod 13 may not be simultaneously provided on the inner wall or outer wall of both sides of the garden bed 11. For example, the first side rod 12 is provided on the inner wall of one side of the garden bed 11, and the second side rod 13 is provided on the outer wall of the other side of the garden bed 11.

In an embodiment, the first side rod 12 and the second side rod 13 can be non-detachably provided on both sides of the garden bed 11. For example, the first side rod 12 and the second side rod 13 can be welded to the garden bed 11.

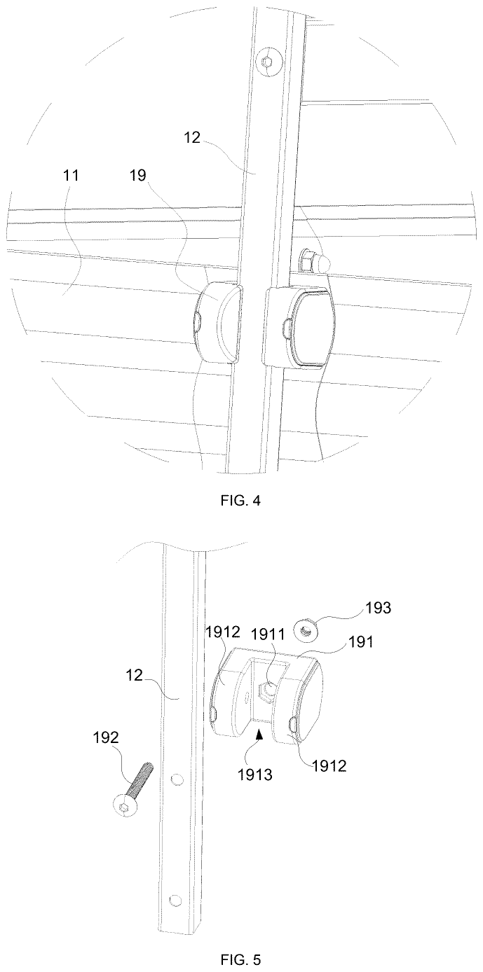

In another embodiment, the first side rod 12 and the second side rod 13 are detachably installed on both sides of the garden bed 11. For example, as shown in FIG. 4, FIG. 4 is an enlarged structural diagram of the area marked B in FIG. 1. The first side rod 12 and the second side rod 13 are respectively detachably installed on both sides of the garden bed 11 through at least one connecting member 19.

In an embodiment, as shown in FIG. 5, FIG. 5 is a structural exploded diagram of a connecting member and a first side rod provided in an embodiment of this application. The connecting member 19 includes a clamping body 191, a first screw 192 and a first nut 193. The clamping body 191 is provided with a first through-hole 1911, one end of the clamping body 191 is shaped to fit a side wall of the garden bed 11, thereby making the clamping body 191 more firmly fixedly connected to the garden bed 11. The other end of the clamping body 191 extends with two clamping parts 1912; two clamping parts 1912 form a clamping space 1913; the clamping space 1913 is for placing the first side rod 12 or the second side rod 13. The first screw 192 is threaded through the first side rod 12 or the second side rod 13, the first through-hole 1911 and the garden bed 11, and connected in the first nut 193 to use the clamping body 191 to install the first side rod 12 or the second side rod 13 on the garden bed 11. Moreover, the garden bed 11 is provided with a plurality of screw holes at different heights, and the relative position of the connecting member 19 and the garden bed 11 can be adjusted according to needs.

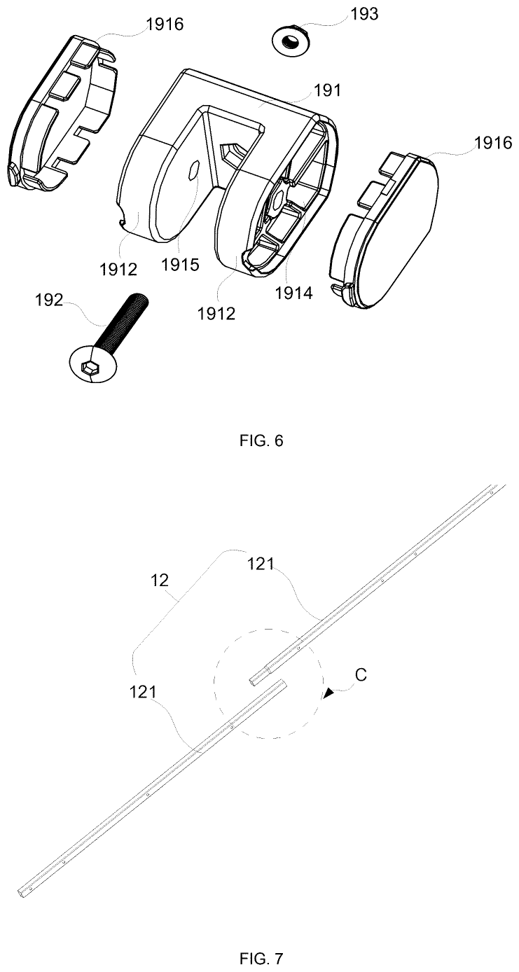

In an embodiment, as shown in FIG. 6, FIG. 6 is a structural exploded diagram of a connecting member provided in an embodiment of this application. A plurality of hollow portions 1914 spaced apart are provided on one side of the clamping part 1912 that is opposite to the first side rod 12 or the second side rod 13, two clamping parts 1912 are respectively provided with a second through-hole 1915. The clamping body 191 further includes a clamping cover 1916, the clamping cover 1916 covers the hollow portions 1914 and the second through-hole 1915. The second through-hole 1915 can be used in conjunction with fixing members such as screws, so as to further more firmly fix the first side rod 12 or the second side rod 13 in the clamping space 1913 and increase the stability of the vine trellis 10.

It should be noted that, the specific structure of the connecting member 19 and the specific method of installing the first side rod 12 and the second side rod 13 on the garden bed 11 are not limited to the situations shown in FIGS. 4 to 6. Other structures and fixing methods can be adopted, and no specific limitation is made here.

In an embodiment, the first side rod 12 and the second side rod 13 can be fixed-length rods or adjustable-length rods. Specifically, when the first side rod 12 and the second side rod 13 are adjustable-length rods, the first side rod 12 and the second side rod 13 all include a plurality of sub-rods, a plurality of sub-rods are detachably connected to lengthen or shorten lengths of the first side rod 12 and the second side rod 13.

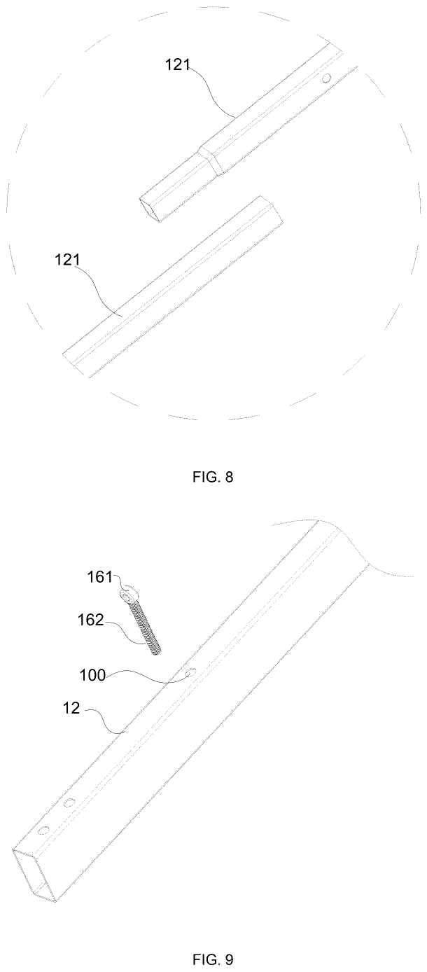

The following takes the first side rod 12 as an example for description. As shown in FIGS. 7 to 8, FIG. 7 is a partial structural diagram of a first side rod provided in an embodiment of this application, FIG. 8 is an enlarged structural diagram of the area marked C in FIG. 7. The first side rod 12 includes a plurality of sub-rods 121, a plurality of sub-rods 121 are detachably connected together. For example, the length of the first side rod 12 can be lengthened by increasing the number of sub-rods 121 connected together, or shortened by reducing the number of sub-rods 121 connected together. Since the lengths of the first side rod 12 and the second side rod 13 are adjustable, users can adjust the height of the subsequently formed net 18 according to the growth characteristics of different climbing plants and surrounding spatial environment, thereby enhancing the versatility of the vine trellis 10.

In the connection method of a plurality of sub-rods 121 shown in FIG. 8, one end of one sub-rod 121 is inserted into one end of another sub-rod 121, so that two sub-rods 121 are connected together. Of course, the connection method shown in FIG. 8 is only one of many methods. The connection method of a plurality of sub-rods 121 can also adopt other methods, and no specific limitation is made here.

In this embodiment, at least one first connecting rod 14 is connected between the first side rod 12 and the second side rod 13. Specifically, as shown in FIG. 1 and FIG. 3b, the first connecting rod 14 is respectively connected to the ends of the first side rod 12 and the second side rod 13 that are away from the garden bed 11. At least one second connecting rod 15 is connected between the first side rod 12 and the second side rod 13. Specifically, as shown in FIG. 1 and FIG. 3b, the second connecting rod 15 is respectively connected to the ends of the first side rod 12 and the second side rod 13 that are close to the garden bed 11. Of course, the second connecting rod 15 can also be connected to the garden bed 11.

In an embodiment, the first connecting rod 14 and the second connecting rod 15 can be fixed-length rods or adjustable-length rods. For example, in the case where the first connecting rod 14 and the second connecting rod 15 are adjustable-length rods, and the first side rod 12 and the second side rod 13 are detachably installed on the garden bed 11, when users need to replace with a garden bed 11 of a different size, they can adjust the lengths of the first connecting rod 14 and the second connecting rod 15 to fit the dimensions of the new garden bed 11. This enhances the versatility of the vine trellis 10.

For example, when users need to increase the number of vine plants, they may need a garden bed 11 with a larger size. The larger size includes increasing the size along the direction of the first connecting rod 14. Users can disassemble the old garden bed 11 from the first side rod 12 and the second side rod 13, extend the lengths of the first connecting rod 14 and the second connecting rod 15 to fit the dimensions of the new garden bed 11, and then connect the new garden bed 11 with the first side rod 12 and the second side rod 13. In this way, the vine trellis 10 with a larger size can be obtained.

In an embodiment, the first connecting rod 14 and the second connecting rod 15 all include a plurality of sub-rods, a plurality of sub-rods are detachably connected to lengthen or shorten lengths of the first connecting rod 14 and the second connecting rod 15. The specific structures of the first connecting rod 14 and the second connecting rod 15 can refer to the specific structure of the first side rod 12 shown in FIG. 7. The length adjustment methods of the first connecting rod 14 and the second connecting rod 15 can refer to the length adjustment method of the first side rod 12 as described above.

In this embodiment, a plurality of rope pulling members 16 are respectively provided on the first side rod 12, the second side rod 13, the first connecting rod 14 and the second connecting rod 15.

In an embodiment, a plurality of rope pulling members 16 can be non-detachably provided on the first side rod 12, the second side rod 13, the first connecting rod 14 and the second connecting rod 15. For example, rope pulling members 16 can be integrally formed with the first side rod 12, the second side rod 13, the first connecting rod 14 and the second connecting rod 15 on which they are located.

In another embodiment, a plurality of rope pulling members 16 can be detachably provided on the first side rod 12, the second side rod 13, the first connecting rod 14 and the second connecting rod 15.

For example, as shown in FIG. 9, FIG. 9 is a partial structural diagram of a vine trellis provided in an embodiment of this application. The rope pulling member 16 includes a rope pulling part 161 and a second screw 162 connected to the rope pulling part 161. The first side rod 12, the second side rod 13, the first connecting rod 14 and the second connecting rod 15 are all provided with at least one screw hole 100. The second screw 162 is connected in the screw hole 100 to install the rope pulling member 16 on the first side rod 12, the second side rod 13, the first connecting rod 14 and the second connecting rod 15.

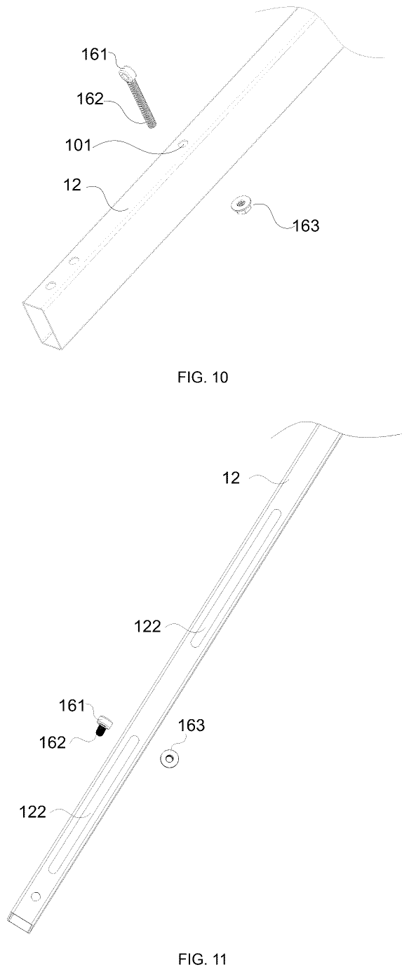

For example, as shown in FIG. 10, FIG. 10 is a partial structural diagram of a vine trellis provided in an embodiment of this application. The rope pulling member 16 includes a rope pulling part 161, a second screw 162 connected to the rope pulling part 161 and a second nut 163. The first side rod 12, the second side rod 13, the first connecting rod 14 and the second connecting rod 15 are all provided with at least one third through-hole 101. The second screw 162 is threaded through the third through-hole 101 and connected in the second nut 163 to install the rope pulling member 16 on the first side rod 12, the second side rod 13, the first connecting rod 14 and the second connecting rod 15.

It should be understood that, the method that a plurality of rope pulling members 16 are detachably provided on the first side rod 12, the second side rod 13, the first connecting rod 14 and the second connecting rod 15 is not limited the method shown in FIGS. 9 and 10. It can also be other ways such as snap-fit connection method. No specific limitation is made here.

In an embodiment, the shape of the rope pulling part 161 includes a round ring, a square ring and/or a hook. Of course, the shape of the rope pulling part 161 can also be any other shape as long as it can hook the rope 17 to form the net 18 required for climbing. No specific limitation is made here.

In an embodiment, a plurality of rope pulling members 16 are fixedly provided on the first side rod 12, the second side rod 13, the first connecting rod 14 and the second connecting rod 15. That is, the positions of the rope pulling members 16 on the first side rod 12, the second side rod 13, the first connecting rod 14 and the second connecting rod 15 are fixed.

In an embodiment, distances between a plurality of rope pulling members 16 provided on the first side rod 12, the second side rod 13, the first connecting rod 14 and the second connecting rod 15 are adjustable, which makes a mesh pattern of the net 18 be adjusted according to a growth of plants.

For example, the first side rod 12, the second side rod 13, the first connecting rod 14 and the second connecting rod 15 are all provided with at least one slot channel. The rope pulling member 16 is threaded through the slot channel, moved to a preset position along the slot channel and fixed at the preset position. Thus, the distances between a plurality of rope pulling members 16 can be adjusted.

In an embodiment, the following takes at least one slot channel provided on the first side rod 12 as an example for description. The relevant structures of the second side rod 13, the first connecting rod 14 and the second connecting rod 15 can refer to the structure of the first side rod 12. As shown in FIG. 11, FIG. 11 is a partial structural diagram of a first side rod provided in an embodiment of this application. The first side rod 12 is provided with at least one slot channel 122. The rope pulling member 16 is threaded through the slot channel 122, moved along the slot channel 122 to a position that is desired by users and fixed at that position by tightening the second nut 163.

In an embodiment, a plurality of rope pulling members 16 are provided on the first side rod 12, the second side rod 13, the first connecting rod 14 and the second connecting rod 15 at equal intervals. The equal intervals can be understood that the distances of a plurality of rope pulling members 16 are equal or approximately equal.

It should be noted that, the distances between a plurality of rope pulling members 16 provided on the different rods can be the same or different. For example, the distances between a plurality of rope pulling members 16 provided on the first side rod 12, the second side rod 13, the first connecting rod 14 and the second connecting rod 15 are all set to 1 cm. For another example, the distances between a plurality of rope pulling members 16 provided on the first side rod 12 and the second side rod 13 are all set to 1 cm, and the distances between a plurality of rope pulling members 16 provided on the first connecting rod 14 and the second connecting rod 15 are all set to 2 cm. For another example, the distances between a plurality of rope pulling members 16 provided on the first side rod 12 are set to 1 cm, the distances between a plurality of rope pulling members 16 provided on the second side rod 13 are set to 1.5 cm, the distances between a plurality of rope pulling members 16 provided on the first connecting rod 14 are set to 2 cm, and the distances between a plurality of rope pulling members 16 provided on the second connecting rod 15 are set to 2.5 cm.

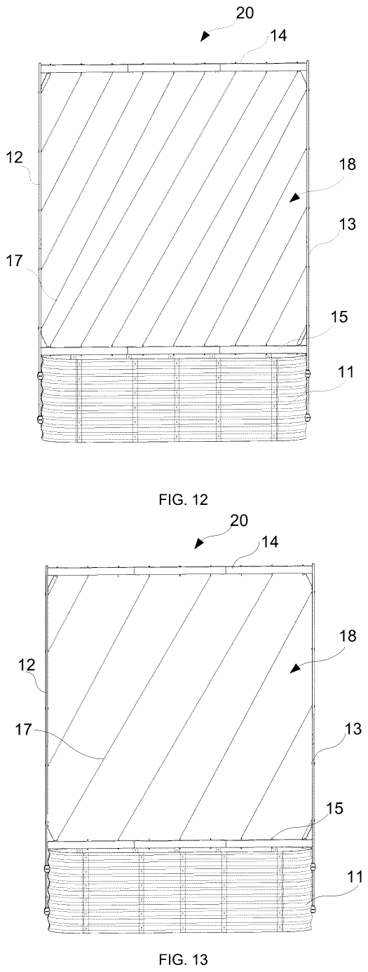

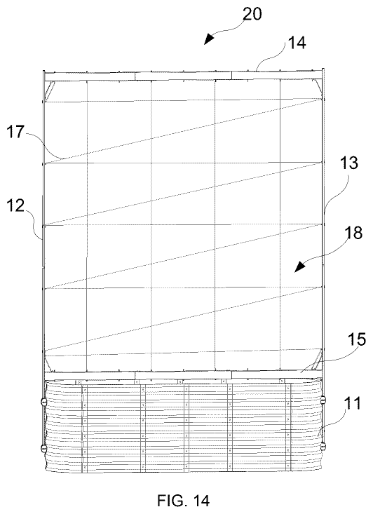

In this embodiment, at least one rope 17 is threaded through a plurality of rope pulling members 16 to form a net 18 required for climbing. It should be understood that, when the rope 17 is threaded through different rope pulling members 16, it can form the nets with different structures. For example, as shown in FIGS. 12 to 14, FIGS. 12 to 14 are all structural diagrams of a planting device provided in an embodiment of this application. When the rope 17 is threaded through different rope pulling members 16, it can form the nets in the planting device shown in FIGS. 12 to 14.

In an embodiment, in order to reinforce the stability of the vine trellis 10, the vine trellis 10 further includes at least one reinforcing rib. At least one reinforcing rib is connected between the first side rod 12 and the first connecting rod 14, between the first side rod 12 and the second connecting rod 15, between the second side rod 13 and the first connecting rod 14, or between the second side rod 13 and the second connecting rod 15. For example, as shown in FIG. 2, the reinforcing rib 102 is connected between the second side rod 13 and the first connecting rod 14, thereby reinforcing the stability of the connection between the second side rod 13 and the first connecting rod 14. Similarly, the reinforcing ribs are all provided between the second side rod 13 and the second connecting rod 15, between the first side rod 12 and the first connecting rod 14, and between the first side rod 12 and the second connecting rod 15, thereby making the vine trellis 10 more stable.

The vine trellis 10 provided by this embodiment, since the first side rod 12 and the second side rod 13 are provided on both sides of the garden bed 11, the first connecting rod 14 and the second connecting rod 15 are respectively connected between the first side rod 12 and the second side rod 13, or the second connecting rod 15 is connected to the garden bed 11, and a plurality of rope pulling members 16 are provided on the first side rod 12, the second side rod 13, the first connecting rod 14 and the second connecting rod 15, thereby making the garden bed 11, the first side rod 12, the second side rod 13, the first connecting rod 14, the second connecting rod 15 and a plurality of rope pulling members 16 form an integral framework. This integral framework can provide guarantee for the stability of the subsequently formed net 18. At the same time, according to users'preferences and the growth characteristics of different vine plants, users can thread the rope 17 through a plurality of rope pulling members 16 following certain weaving rules to form the net 18 required for each vine plant to climb. In this way, the vine trellis 10 provided in the embodiments of this application can not only provide a stable support required for vine plants to climb, but also provide more climbing directions for vine plants.

In the description of this application, it should be noted that, unless otherwise clearly specifically defined and limited, the terms “installed”, “connected”, and “joined” should be broadly understood. For example, it can be a fixed connection, a detachable connection, or an integrated connection. For those of ordinary skill in the art, the specific meanings of these terms in this application can be understood according to specific circumstances.

The above disclosure provides many different implementation methods or examples to realize different structures of this application. In order to simplify the disclosure of this application, the components and settings of specific examples are described above. Of course, they are only examples and are not intended to limit this application. Any non-substantive changes and substitutions made by those skilled in the art on the basis of this application fall within the scope of protection claimed by this application.

In addition, this application can repeat reference numbers and/or reference letters in different examples. This repetition is for the purpose of simplicity and clarity.

What is claimed is:

1. A vine trellis, applied to a planting device, comprising:
a first side rod and a second side rod, the first side rod and the second side rod are respectively provided on both sides of a garden bed of the planting device;
a first connecting rod, the first connecting rod is connected between the first side rod and the second side rod;
a second connecting rod, the second connecting rod is connected between the first side rod and the second side rod, or the second connecting rod is connected to the garden bed;
a plurality of rope pulling members, the plurality of rope pulling members are respectively provided on the first side rod, the second side rod, the first connecting rod and the second connecting rod;
a rope, the rope is threaded through the plurality of rope pulling members to form a net required for climbing.

2. A vine trellis according to claim 1, wherein distances between the plurality of rope pulling members provided on the first side rod, the second side rod, the first connecting rod and the second connecting rod are adjustable, which makes a mesh pattern of the net be adjusted according to a growth of plants.

3. A vine trellis according to claim 1, wherein the plurality of rope pulling members are fixedly provided on the first side rod, the second side rod, the first connecting rod and the second connecting rod.

4. A vine trellis according to claim 2, wherein the plurality of rope pulling members are provided on the first side rod, the second side rod, the first connecting rod and the second connecting rod at equal intervals.

5. A vine trellis according to claim 2, wherein the first side rod, the second side rod, the first connecting rod and the second connecting rod are all provided with at least one slot channel, a rope pulling member is threaded through a slot channel, moved to a preset position along the slot channel and fixed at the preset position.

6. A vine trellis according to claim 1, wherein the first side rod and the second side rod are respectively detachably installed on an inner wall or outer wall of both sides of the garden bed through at least one connecting member.

7. A vine trellis according to claim 6, wherein a connecting member comprises:
a clamping body, the clamping body is provided with a first through-hole, one end of the clamping body is shaped to fit a side wall of the garden bed, the other end of the clamping body extends with two clamping parts, the two clamping parts form a clamping space, the clamping space is for placing the first side rod or the second side rod;
a first screw and a first nut, the first screw is threaded through the first side rod or the second side rod, the first through-hole and the garden bed and connected in the first nut to use the clamping body to install the first side rod or the second side rod on the garden bed.

8. A vine trellis according to claim 7, wherein a plurality of hollow portions spaced apart are provided on one side of the clamping part that is opposite to the first side rod or the second side rod, the two clamping parts respectively are provided with a second through-hole;
the clamping body further comprises a clamping cover, the clamping cover covers the plurality of hollow portions and the second through-hole.

9. A vine trellis according to claim 1, wherein the rope is threaded through different rope pulling members to form the net with different structures.

10. A vine trellis according to claim 1, wherein a rope pulling member comprises:
a rope pulling part;
a second screw, connected to the rope pulling part, the first side rod, the second side rod, the first connecting rod and the second connecting rod are all provided with at least one screw hole, the second screw is connected in a screw hole to install the rope pulling member on the first side rod, the second side rod, the first connecting rod and the second connecting rod; or
a rope pulling member comprises:
a rope pulling part;
a second screw, connected to the rope pulling part;
a second nut, the first side rod, the second side rod, the first connecting rod and the second connecting rod are all provided with at least one third through-hole, the second screw is threaded through a third through-hole and connected in the second nut to install the rope pulling member on the first side rod, the second side rod, the first connecting rod and the second connecting rod.

11. A vine trellis according to claim 10, wherein a shape of the rope pulling part comprises a round ring, a square ring and/or a hook.

12. A vine trellis according to claim 1, wherein the first side rod, the second side rod, the first connecting rod and the second connecting rod all comprise a plurality of sub-rods, the plurality of sub-rods are detachably connected to lengthen or shorten lengths of the first side rod, the second side rod, the first connecting rod and the second connecting rod.

13. A vine trellis according to claim 1, wherein the vine trellis further comprises a reinforcing rib, the reinforcing rib is connected between the first side rod and the first connecting rod, between the first side rod and the second connecting rod, between the second side rod and the first connecting rod, or between the second side rod and the second connecting rod.

14. A planting device, comprising:
a garden bed, the garden bed is configured to place plants;
a vine trellis, the vine trellis is connected with the garden bed, wherein the vine trellis comprises:
a first side rod and a second side rod, the first side rod and the second side rod are respectively provided on both sides of the garden bed;
a first connecting rod, the first connecting rod is connected between the first side rod and the second side rod;
a second connecting rod, the second connecting rod is connected between the first side rod and the second side rod, or the second connecting rod is connected to the garden bed;
a plurality of rope pulling members, the plurality of rope pulling members are respectively provided on the first side rod, the second side rod, the first connecting rod and the second connecting rod;
a rope, the rope is threaded through the plurality of rope pulling members to form a net required for climbing.

15. A planting device according to claim 14, wherein distances between the plurality of rope pulling members provided on the first side rod, the second side rod, the first connecting rod and the second connecting rod are adjustable, which makes a mesh pattern of the net be adjusted according to a growth of plants.

16. A planting device according to claim 14, wherein the first side rod and the second side rod are respectively detachably installed on an inner wall or outer wall of both sides of the garden bed through at least one connecting member.

17. A planting device according to claim 16, wherein a connecting member comprises:
a clamping body, the clamping body is provided with a first through-hole, one end of the clamping body is shaped to fit a side wall of the garden bed, the other end of the clamping body extends with two clamping parts, the two clamping parts form a clamping space, the clamping space is for placing the first side rod or the second side rod;
a first screw and a first nut, the first screw is threaded through the first side rod or the second side rod, the first through-hole and the garden bed and connected in the first nut to use the clamping body to install the first side rod or the second side rod on the garden bed.

18. A planting device according to claim 17, wherein a plurality of hollow portions spaced apart are provided on one side of the clamping part that is opposite to the first side rod or the second side rod, the two clamping parts respectively are provided with a second through-hole;
the clamping body further comprises a clamping cover, the clamping cover covers the plurality of hollow portions and the second through-hole.

19. A planting device according to claim 14, wherein a rope pulling member comprises:
a rope pulling part;
a second screw, connected to the rope pulling part, the first side rod, the second side rod, the first connecting rod and the second connecting rod are all provided with at least one screw hole, the second screw is connected in a screw hole to install the rope pulling member on the first side rod, the second side rod, the first connecting rod and the second connecting rod; or
a rope pulling member comprises:
a rope pulling part;
a second screw, connected to the rope pulling part;
a second nut, the first side rod, the second side rod, the first connecting rod and the second connecting rod are all provided with at least one third through-hole, the second screw is threaded through a third through-hole and connected in the second nut to install the rope pulling member on the first side rod, the second side rod, the first connecting rod and the second connecting rod.

20. A planting device according to claim 14, wherein the first side rod, the second side rod, the first connecting rod and the second connecting rod all comprise a plurality of sub-rods, the plurality of sub-rods are detachably connected to lengthen or shorten lengths of the first side rod, the second side rod, the first connecting rod and the second connecting rod.
